(19) United States
(12) Patent Application Publication
(10) Pub. No.: US 2007/0063370 A1
(43) Pub. Date: Mar. 22, 2007

(54) MOLDING SYSTEM AND METHOD

(75) Inventors: David Steinberger, Sunbury, OH (US); Dirk N. Yerian, Akron, OH (US)

Correspondence Address: PEARNE & GORDON LLP, 1801 EAST 9TH STREET, SUITE 1200, CLEVELAND, OH, 44114-3108, US

(73) Assignee: New Heat LLC, Columbus, OH (US)

(21) Appl. No.: 11/532,154

(22) Filed: Sep. 15, 2006

Related U.S. Application Data
(60) Provisional application No. 60/717,839, filed on Sep. 16, 2005.

(51) Int. Cl. B27N 3/00

(52) U.S. Cl. 264/109; 264/310; 425/403.1

(57) ABSTRACT

A molding system includes a single molding machine, or station, having one or more molds therein, wherein the single machine, or station, is operable to both heat and cool the material present within the one or more molds while rotating the mold. The single machine, or station, can also be loaded with starting material and unloaded directly at the machine.

### FIELD OF THE INVENTION

The present invention relates to material processing, and more particularly, to systems and methods for molding plastics and other materials with heat.

### BACKGROUND OF THE INVENTION

One particular type of molding, rotational molding, also referred to as rotomolding, is a widely used process to produce hollow articles such as toys, sporting equipment, containers, water tanks, etc. The rotomolding process includes introducing a known amount of plastic in powder form into a hollow, shell-like mold. The mold is rotated about two or more principal axes at relatively low speeds as it is heated in an oven so that the plastic enclosed in the mold adheres to and forms a monolithic layer against the mold surface. When the mold rotates in the oven, the mold's metal wall becomes hot and the surface of the powder particles becomes tacky. The particles stick to the mold wall and to each other, thus building up a loose powdery mass against the mold wall. A major portion of the molding cycle is then taken up in sintering the loose powdery mass until it is a homogeneous melt. The mold rotation continues during the cooling phase so that the plastic retains its desired shape as it solidifies. When the plastic is sufficiently rigid, the cooling and mold rotation is stopped to allow the removal of the plastic product from the mold. At this stage, the molding process or cycle may be repeated to make additional products.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, a molding system is provided. The system includes: at least one molding machine having at least one mold therein, the at least one mold being substantially layered or coated with an electrothermic layer or coating, the electrothermic layer or coating being adapted to heat material present within the at least one mold; a conveyor line associated with each machine for moving at least one completed part away from the at least one molding machine; and at least one assembly and/or packing station for receiving the at least one completed part from the conveyor line.

In accordance with another aspect of the present invention, a molding machine comprises: at least one mold, the mold being adapted to receive material within an interior portion of the mold; an electrothermic layer or coating applied to a portion of an outer surface of the mold; and at least two electrodes spaced across the electrothermic layer or coating, wherein the electrothermic layer or coating is adapted to conduct heat substantially evenly over the area of the mold painted or otherwise coated with the electrothermic material.

In accordance with another aspect of the present invention, a molding method is provided. The molding method includes: loading a powdered material into a mold; heating the mold via an electrothermic layer or coating applied to a surface of the mold to a first predetermined temperature, the first predetermined temperature being suitable for fully melting the powdered material; and once the material has been fully melted, cooling the mold via cooling lines coupled to the mold.

In a broad sense, the invention involves the provision of an electrothermic material layer arranged to contact a material being processed with heat transfer from the electrothermic layer or to contact an intermediate layer or layers of which one is in direct contact with the material being heat processed with heat transfer from the electrothermic layer, the electrothermic layer or the intermediate one layer being capable of assisting to shape or maintaining the shape of the material being so processed. The electrothermic layer is advantageously arranged to substantially envelop the material being processed or at least arranged to be substantially co-extensive with a large portion of the surface of the material being processed whereby the conductive heat transfer area is relatively large, being preferably at least about ⅓, and more preferably at least about ½, and most preferably at least about ¾, of the surface being shaped or maintained of a side of the material being processed, so as to promote a high rate of heat transfer between the electrothermic layer and the material being processed.

To the accomplishment of the foregoing and related ends, the invention then, comprises the features hereinafter fully described. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 illustrates a schematic diagram of a conventional rotational molding process;

FIG. 2 illustrates a rotational molding system in accordance with an aspect of the present invention;

FIG. 3 illustrates an example of a mold in accordance with an aspect of the present invention;

FIG. 4 illustrates an example of a cross sectional view of a mold wall in accordance with an aspect of the present invention;

FIG. 5 illustrates a graphical representation of a conventional rotational molding process;

FIG. 6 illustrates a graphical representation of a rotational molding process in accordance with an aspect of the present invention;

FIG. 7 illustrates an example of a rotational molding station in accordance with an aspect of the present invention;

FIG. 8 illustrates another example of a rotational molding station in accordance with an aspect of the present invention;

FIG. 9 illustrates a representation of a rotary arm for a rotational molding machine in accordance with an aspect of the present invention;

FIG. 10 illustrates another example of a cross sectional view of a mold wall in accordance with an aspect of the present invention;

FIG. 11 illustrates a methodology for a molding process in accordance with an aspect of the present invention; and

FIG. 12 illustrates a methodology for manufacturing a mold in accordance with an aspect of the present invention.

### DETAILED DESCRIPTION OF THE INVENTION

The present invention provides systems and methods for processing material being heated and shaped such as occurs in rotational molding. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the reading of the drawings. In the following description, for purposes of explanation, numerous specific details are set forth in order to provide a thorough understanding of the present invention. It should be evident, however, that the present invention may be practiced without these specific details.

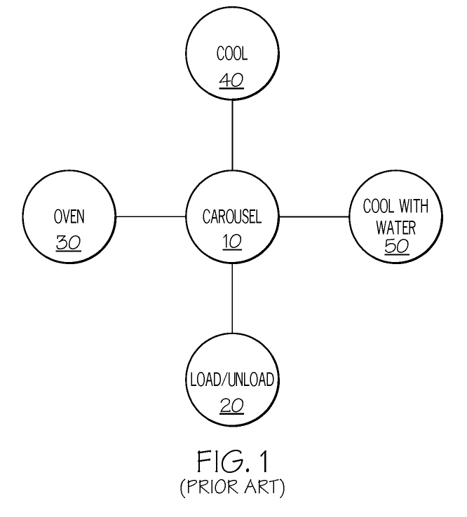

Referring initially to FIG. 1, a conventional rotational molding, or rotomolding, system is illustrated. The conventional system includes a carousel 10 having four stations: a stationary load/unload station 20, a rotating oven, or heat, station 30, a rotating cool station 40, and a rotating cool with water station 50. At the load and unload station 20, starting material is placed in a mold. The filled mold is then heated at the oven station 30 while being rotated about one, two, or more axes. The rotation of the mold facilitates displacement of the starting material to cover the walls of the mold. After obtaining the desired distribution of the material over the walls of the mold, the temperature of the mold is decreased at the cool station 40 as rotation of the mold continues. The decrease in temperature allows the molten material to solidify in the shape of the mold cavity. To further decrease the temperature, the mold is moved to a secondary cool station 50 where cooling lines, air, and/or water vapors are employed to cool the article. When the article is sufficiently cooled, the article is removed from the mold at the load/unload station 20 and the process is repeated.

The typical cycle time per station 20, 30, 40, 50 in the conventional rotational molding system averages about 15 minutes. When the mold enters the oven station 30 from the load/unload station 20, the mold is typically at about 110-degrees F. The powdered material in the mold is typically at room temperature. In order to effectively change the starting powdered material to a substantially molten state, the powdered material must be heated to about 320-degrees F. Alternatively or additionally, the internal mold temperature is monitored and heated to about 200-degrees F. This translates into heating the oven to a temperature of about 650-degrees F. Thus, the oven station 30 must heat the material in the mold from room temperature to about 320-degrees F. and the oven from about 110-degrees F. to about 650-degrees F. However, due to a ramping up effect of the heat from the oven station 30, the mold is actually pulled from the oven station 30 when the material within the mold reaches about 300-degrees F. Thus, the material in the mold is placed into the oven station 30 ‘cold’ and gradually ramps up to 320-degrees F. At the first cool station 40, the material gradually ramps back down to about 230-degrees F. at which point, the part separates from the mold. However, if the part is removed from the mold at this point, the part will generally not be able to hold tight tolerances and may warp. Accordingly, when tolerances are critical, the mold enters a second cool station 50, which utilizes water cooling to further chill the mold, thereby cooling the part until it reaches about 110-degrees F. Thus from the start of the conventional rotational molding process to the end, it typically takes about one hour to receive completed parts from one mold. Because there are four stations 20, 30, 40, 50 on the carousel 10, four times the number of parts that can be produced in one mold can be realized in one hour. Thus, for the sake of discussion, if one part is produced per mold and each station only held one mold, an operator would realize about 4 parts per hour from the rotational molding system.

It is to be appreciated that the times and temperatures discussed herein will vary depending upon the type of starting material and the configuration of the final product, and specific times and temperatures are only mentioned herein for ease of discussion.

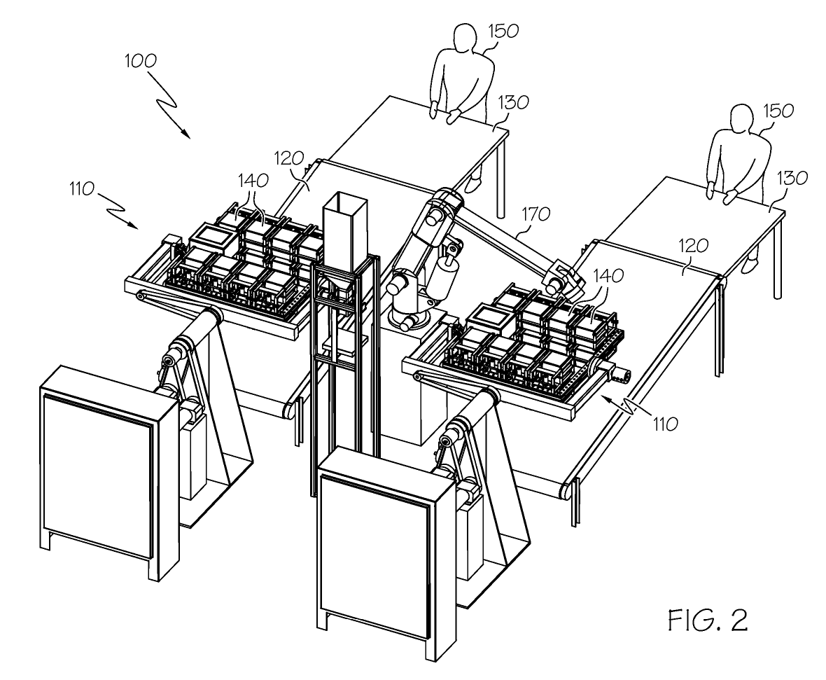

Turning now to FIG. 2, an example of a rotational molding system 100 is illustrated in accordance with an aspect of the present invention. The rotational molding system 100 includes one or more rotational molding machines 110, a conveyor line 120 associated with each machine, and an assembly and/or packing station 130. Each machine can have it's own assembly and/or packing station 130, as illustrated in FIG. 2. Alternatively, the conveyor lines can all lead to one assembly and/or packing station. Each rotational molding machine 110 is independently adapted to produce a final part from powdered material within one machine, or one station 110. Thus, each rotational molding machine 110 in accordance with the present invention replaces the carousel and four stations of the conventional system (e.g., 10-50 of FIG. 1).

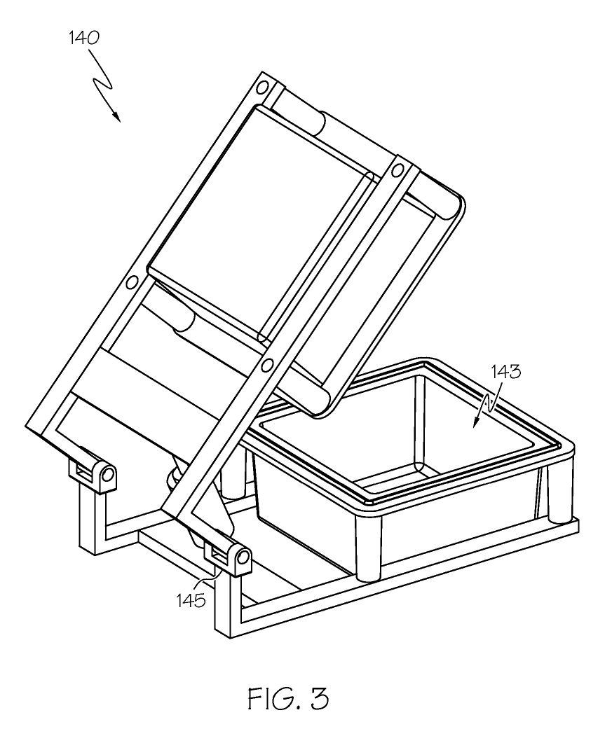

More specifically, each rotational molding machine 110 includes one or more molds 140 therein. For ease of discussion and comparison to the prior art system, the rotational molding machine of the present invention will be described herein as having one mold, which can produce one part per mold. An example of a mold 140 is illustrated in FIG. 3. The mold includes a cavity portion 143 for receiving material therein and the mold can open and close via a hinge assembly 145. However, it is to be appreciated that any suitable mold size, shape, and configuration can be employed with the present invention.

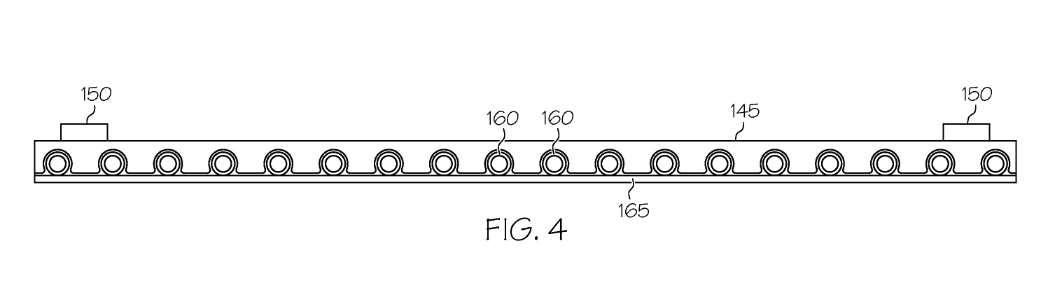

A cross sectional view of a portion of the mold is illustrated in FIG. 4 in accordance with an aspect of the present invention. The mold wall 165 is coated with an electrothermic layer or coating of material 145 that can be heated to and held at any desired temperature. The electrothermic layer or coating 145 can be substantially similar to the electrothermic coatings disclosed in U.S. Pat. Nos. 6,086,791 and 6,818,156, the contents of which are incorporated by reference herein. For instance, the electrothermic layer or coating 145 can operatively hold the mold at any temperature up to and including 2300 degrees F. if materials were available to operate at that heat. The electrothermic layer or coating 145 can be formulated to produce a predetermined temperature when excited by a design voltage. Alternatively or additionally, the temperature of the electrothermic layer or coating 145 can be controlled via a variable electric power supply or the like. The electrothermic layer or coating 145 is heated via a configuration of electrodes 150 positioned over a surface of the mold 165 and in electrical contact under, inside, or outside the electrothermic layer or coating 145. The electrodes 150 can be in the form of a thin metal foil, electroplated metal film, perforated metal sheet or any other suitable form of electrical conductor. The electrodes are electrically charged and the electrothermic layer or coating 145 acting like a heater element evenly or unevenly warms to the predetermined temperature. The electrothermic layer or coating 145 operates to evenly conduct the heat over a surface of the electrothermic layer and the area it covers such as the surface of the mold wall 165 bringing it to a desired temperature. The electrodes can be powered by a typical power supply, such as a 12, 24, 110-120, 220-240, and/or 440-480 volt electrical connection. The electrothermic layer or coating 145 is formulated for the voltage to be used and heat needed (e.g. a 110-volt or 220-volt electrical connection). Because the mold can be heated directly and independently via the electrodes and electrothermic layer or coating configuration, the oven station of the conventional rotational molding system can be eliminated. In other words, the mold itself acts as an oven to heat the powdered material in the mold.

The electrodes 150 can be a conductive layer on each side of the electrothermic layer or two strips of copper or other conductive material at the edges or boundary of the electrothermic coating. The electrothermic layer is operable to heat the mold to its desired temperature within seconds rather than minutes. Accordingly, the time it takes to fully heat the powdered material to its predetermined melting temperature is largely dependent upon the properties of the powdered material and less on the rotational molding machine, as is in the conventional system, because the heat process is now performed by a heating layer that, in effect is part of the mold itself.

To cool the material in the mold, cooling lines 160, which can be metal lines inserted, electroplated, or molded around the mold material 165 are provided for conducting air and/or other coolant lines. Alternatively or additionally, cooling of the mold can be accomplished by air and/or water vapors forced over the exterior of the mold. Thus, both cooling stations of the prior art rotational molding system can be eliminated. Like the heating system of the mold, the cooling system can effectively cool the material in the mold within seconds. The actual cooling time is largely dependent upon the properties of the material. Accordingly, the prior art carousel with four stations (FIG. 1) can now be replaced with a single work cell in which powdered material can be loaded into a mold, heated and cooled, and a resultant part can be unloaded.

As discussed above, the typical cycle time per station in the conventional rotational molding system 20-50 averages about fifteen minutes. In contrast, in the present rotational molding system 100, the process with the longest cycle time does not limit any other process. Instead, each of the loading, heating, cooling, and unloading operations is independent. The entire cycle for the rotational molding process can be about six minutes from start to completion. However, it is to be appreciated that each operation can be of any shortened cycle time based upon the mold 140, the characteristics of the parts being molded, including a desired thickness, and the material being molded. Loading and unloading of the powdered material and part, respectively, can be achieved via automation. Automation was often not feasible in the conventional rotational molding process due to the necessity of placing a rotary arm, which supports the mold 140, into the harsh environment of the oven station. In the present system, only the mold 140 is heated, thus the arm that supports the mold 140 and enables it to rotate can be automated. Again, with the assumption that each machine 110 holds one mold 140, which produces one part, about ten parts per hour can be realized from one machine 110, in contrast to the four parts per hour from the conventional system. The required floor space or footprint of the rotational molding machine 110 of the present invention is substantially smaller than the prior art system. At least four of the present rotational molding machines 110 can be placed within the same floor space as a single prior art rotational molding system 10-50. Four machines 110 can produce approximately forty parts/hour. Thus, within about the same floor space, production can be increased as much as tenfold. Again, it is recognized that cycle times are a factor of the properties of the powdered material employed and the characteristics of the parts being molded, including a desired thickness, for example. Further, it is recognized, that a single rotary arm can be adapted to hold up to 60 parts or more.

The present invention also realizes advantages in production during mold changes and/or during machine maintenance. For instance, in the prior art system, when a mold change is desired, all four stations 20-50 need to be halted. Accordingly, no production is achieved during a mold change in the prior art system. Thus, approximately two hours, including mold change time, are lost during a mold change: one hour to cycle parts out of the system and another hour to ramp the system back up. With the four independent systems of the present invention, three machines can produce product during a mold change in one machine.

The configuration of the mold 140 also substantially mitigates the need for auxiliary operations, such as trimming, in accordance with an aspect of the present invention. In conventional rotational molding, trimming is necessary as the entire mold is heated, thereby coating the entire mold with molten material. The entire mold is heated in the conventional system because the entire mold is placed within the oven environment. In contrast, in the current process, the entire mold 140 does not need to be heated. Thus, if one or more apertures are desired in a part at specified locations, corresponding locations on the mold 140 are not covered with electrodes and the electrothermic layer or coating. The body of the mold 140 can be manufactured from a nonconductive material, such as epoxy, ceramic, etc. or shielded so that the mold surfaces not associated with the electrothermic material do not conduct heat. During the rotational molding process, the powdered material will not stick to the non-heated areas of the mold, thereby creating the desired apertures without a separate trimming operation. Cooling lines can alternatively or additionally be positioned along areas of the mold 140 in which apertures, or the like, are desired. Further, a robot 170 or other suitable device can be positioned between the rotational molding machine 110 and a conveyor line 120 to unload the part from the mold 140 and place the finished part on the conveyor line 120. The robot can also be used for loading powdered material into the molds 140. Further, the robot can be positioned between adjacent molding stations for operating the loading and unloading of the molds at both stations. Eject cylinders can be more readily added to the mold design because the mold 140 does not go into an oven. Because auxiliary operations are no longer needed in the current rotational molding process, an operator 150 can be positioned at the assembly and/or packing station 130 at the end of the conveyor line 120 to package the resultant part directly from the mold 140.

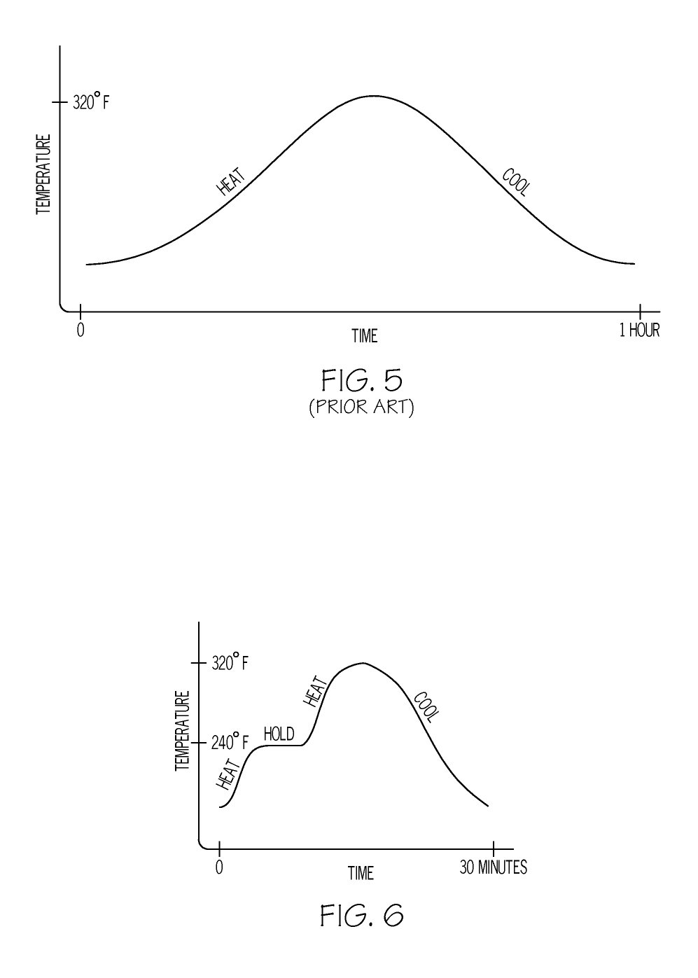

FIGS. 5 and 6 show graphical representations of the prior art rotational molding process and the present rotational molding process, respectively. The graphs of FIGS. 5 and 6 are not drawn to scale and are for illustrative purposes only. FIG. 5 depicts the heating and cooling process of the prior art system in which the material in the mold gradually ramps up to about 320-degrees F. and then gradually falls down to near room temperature. The entire heating and cooling process for the prior art system takes about one hour, as discussed above.

Turning now to FIG. 6, the mold can be set at a first predetermined temperature during a loading process. The first predetermined temperature is preferably a temperature below the melting point of the powdered material (e.g., 240-degrees F.). The mold is operable to hold the temperature at the first predetermined temperature until all of the powdered material has been loaded into the mold. Once the loading operation is complete, the mold can then be heated to a second predetermined temperature. The second predetermined temperature is preferably a suitable temperature for fully melting the powdered material (e.g., 320-degrees F.) to a suitable viscosity for coating the mold. Heating the material to the first predetermined temperature reduces the time needed to bring the material to the second predetermined temperature. Once the material has been fully melted and the mold has been sufficiently coated, the mold is cooled down via the integrated cooling lines and air and water mist. The entire heating and cooling process for the present system can be about six minutes, for example. Again, it is to be appreciated that the times and temperatures discussed herein will vary depending upon the type of starting material and the configuration of the final product, and specific times and temperatures are only mentioned herein for ease of discussion.

The number of electrode strips or layers needed for a single mold is dependent upon the size and design of the mold. For instance, the mold can be covered with many electrode strips or layers. In order to provide even heating of the mold, the electrodes are preferably substantially evenly spaced over the surface of the mold. A software program can be employed to quickly determine the exact locations of the electrodes to provide even heating of the mold in the desired areas. The electrode conductive strips or foils can be manually placed, silk screened or etched on the mold. However, it is to be appreciated that the electrodes can be positioned on the mold in any other suitable manner. The electrodes can operate to form distinct heat zones for the mold. Accordingly, the mold can be designed to vary the thickness in different areas of the part by adjusting the heat input in the corresponding areas of the mold. For instance, if a thicker area of the part is desired, the corresponding area of the mold can be designed with higher temperature electrodes and electrothermic layer or coating or increasing the voltage applied to the electrodes. Likewise, if a thinner area of the part is desired, the corresponding area of the mold can be designed with lower temperature electrodes and electrothermic layer or coating or by reducing the voltage to the desired zone. As can be appreciated from the foregoing, the material wall thickness of the part can be controlled via the electrodes and electrothermic layer or coating. Alternatively or additionally, the material wall thickness can be controlled via the rotation of the mold.

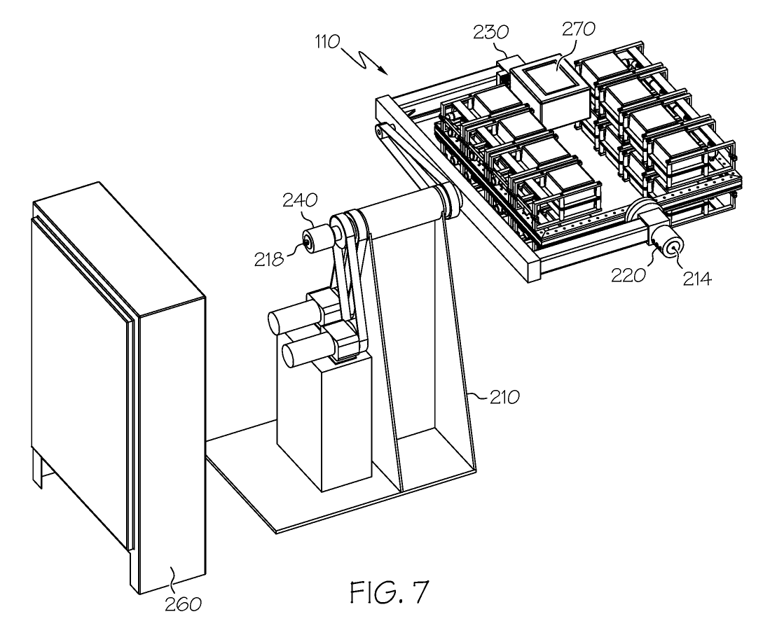

FIG. 7 illustrates the rotational molding machine system 110 in greater detail in accordance an aspect of the present invention. The system 110 includes a rotational molding machine 210 that can rotate about two axes. First and second axes 214 and 218 are shown in FIG. 7 although it is to be appreciated that any number of axes having any desired orientation can be employed. The machine can have two posts 220, 230 along the first axis 214 and one post 240 along the second axis 218. One or more of the posts 220, 230, 240 can be employed to pipe fluid into the system for the cooling lines and/or electrical wiring to the system. Another application for the fluid lines is to operate any automated clamping, slide assemblies and ejector pins. The fluid can be any suitable cooling fluid, such as, air, oil, water, antifreeze-like coolant, etc. Although, not illustrated, the machine can be adjacent an operator platform for maintenance, repair, mold change, etc. A controller 260 can also be provided to operate the rotational molding machine 210. The controller 260 can retrieve a computer program based upon the mold set up in the machine 210. The computer programs can be stored in the controller 260 or in a remote location and can include a catalog of each mold program. Each mold program includes specific parameters, including heating configurations, run times, temperatures, etc. Thus, the controller 260 can call up a part number based upon the mold set up, reload all the relevant parameters, and run the rotational molding process. Also the materials can be changed so the program can identify what material is being used and adjust the process sequence and/or conditions to produce the same quality part in the same mold with different materials. The programs can also include robot programs to instruct a robot to properly load the powdered material and unload the parts from the mold.

The mold can also include movable parts (e.g., slides, cylinders, etc.) to create sophisticated part configurations. For instance, undercuts can be created in a part by utilizing a mold with a slidable member that can slide out of engagement with the cooled part to facilitate pulling of the part from the mold. The movable mold parts can be operated via the controller 260.

The controller 260 can also receive information from a logging device 270 positioned within the rotational molding environment. The logging device 270 is constructed to withstand the high temperatures of the molding environment. Data from the mold and the environment is collected by the logging device 270 and conveyed to an operator, such that the operator can determine how the plastic is curing and whether the process needs any adjustments. A wireless PC can be employed in addition to or in place of the controller 260 for wireless operation of the rotational molding system 200. The wireless system can also convey the production information to the office network so that production reporting can be in real time.

As shown in FIG. 8, parts produced by the rotational molding machine 210 can be unloaded by a robot 265 and placed onto a conveyor system 280, which leads to an assembly and/or packing area 290. A material holding system, or hopper, 295 can also be provided to supply raw material to the molds 140. The robot 265 can facilitate in loading the material from the hopper 295 to the molds 140.

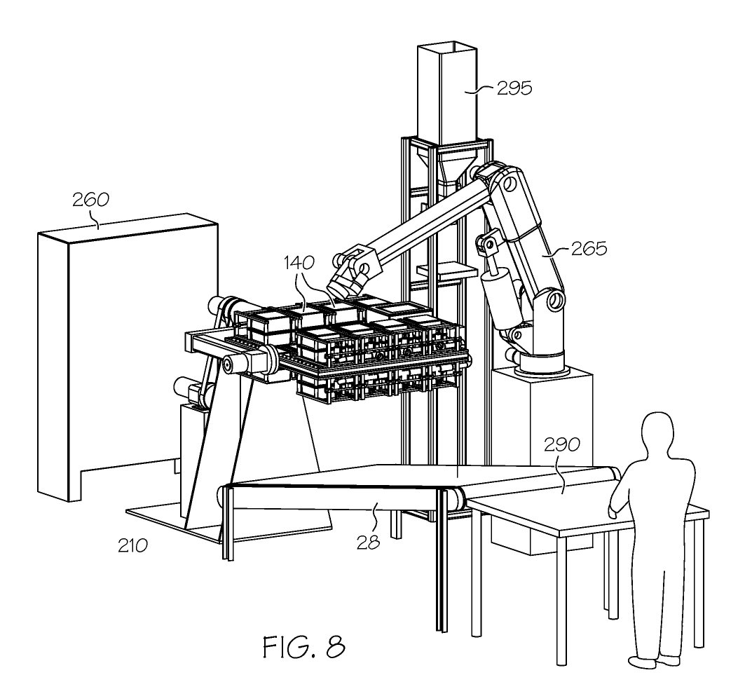

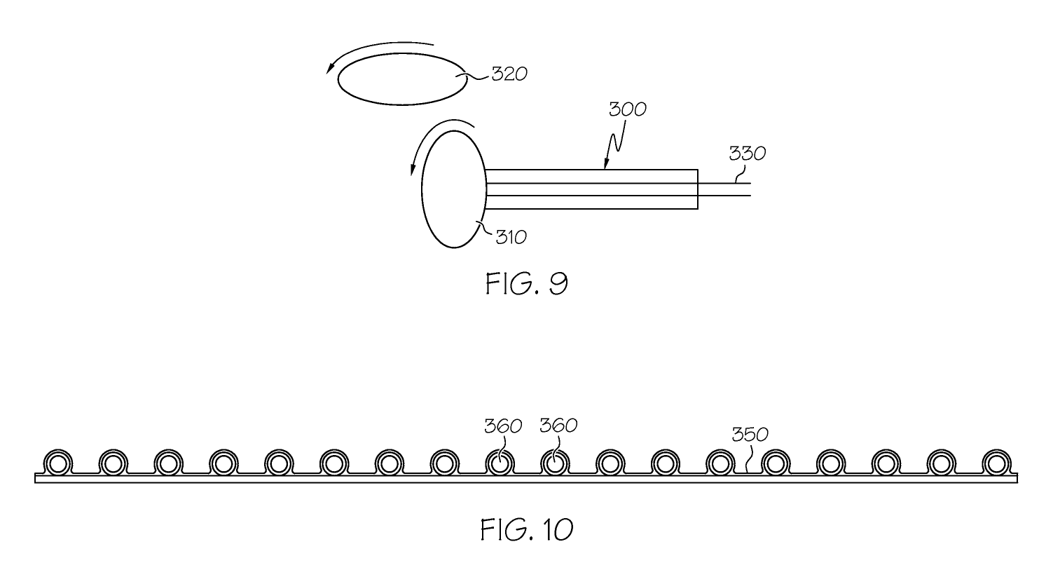

FIG. 9 illustrates a representation of a rotary arm 300 for a rotational molding machine. The rotary arm 300 includes an arm having a gear 310 coupled to one end for rotation of the machine in a first direction. An assembly (not shown) can mount to the arm 300 with another gear 320 for rotation of the machine in a second direction. Thus, the machine can operatively rotate a mold therein in both directions. Because the arm 300 does not need to withstand a harsh oven environment, as in the prior art, electrical controls and fluid control and cooling lines can be piped through a bore 330 located in a central portion of the arm 300.

It is to be appreciated that one skilled in the art will realize various configurations that can be employed with the present invention. For instance, as shown in FIG. 10, rather than layering or coating the mold with the electrothermic material, the electrothermic material can be mixed into or may comprise the material 350 used to manufacture the mold. Thus, the mold material 350 itself will operate to generate heat when suitably placed electrodes are electrically energized. Cooling lines 360 can be provided within the mold material 350 for cooling of the mold.

Further, it is to be appreciated that any suitable material can be molded with the rotational molding machine and process of the present invention. For instance, the rotational molding machine has a capacity of heating up to 2300-degrees F. Thus, any material that can melt, flow, and cure under 2300-degrees F. can be utilized with the rotational molding machine.

Another advantage of the present rotational molding machine is realized in the operation costs. The heating and cooling systems for the rotational molding machine of the present invention operate via a typical energy source (e.g., 110-volt, 220-volt, 440-volt electrical connection) and are almost 100% efficient electrically at producing infrared heat. This can result in an energy cost savings of about 60-80 percent as compared to the conventional rotational molding systems, which have high energy costs associated with heating the oven station.

The rotational molding process of the present invention can also produce parts having a metal core or metal support structure. The metal core or support structure can be coated with electrodes and electrothermic layer or coating in a manner similar to the layering or coating on the surface of the mold and placed within the mold. Thus during the heating and rotating of the powdered material, the powdered material will melt and adhere to the metal core or support structure as well as to the surface of the mold. Thus, the metal core or support structure can be integrally formed with the plastic part.

Many industries can benefit from the present invention. For instance, the automotive industry is currently molding plastic parts and physically attaching the plastic parts to a metal structure. Now, because metal parts can be coated with electrodes and electrothermic layer or coating, which can be utilized as a heat source, the metal parts can be placed directly into the mold for the plastic parts. Accordingly, a vehicle body can be rotationally molded along with the steel vehicle frame, thereby building a collision protection structure within the plastic of the vehicle. Further, because the electrodes and electrothermic layer or coating remain present on the metal parts of the vehicle, the metal parts can be heated to mitigate snow and/or ice-build up on the vehicle.

Similarly, in the airline industry, an entire internal aircraft structure can be rotationally molded with metal support structures. The metal structures can be painted with electrothermic material (heat paint) where the plastic material is desired and left unpainted where no plastic material is desired. The entire structure can be mounted within one mold. Again, because the electrodes and heat paint remain on the metal structures, the aircraft now includes built in deicing capabilities. A 12-volt power source can be utilized to heat the painted surface to above freezing temperatures.

For instance, in the toy industry, the present rotational molding process can be utilized to create electrically powered cars. The cars could be made with the entire drive system inside the molded body and the wheels and axles left on the outside of the mold because they will not be harmed in the molding process so that a complete toy assembly can be molded with this process. Electrical components and other devices can be molded inside of the part, providing the components can take the 200-degree or necessary internal core temperature.

The present invention can also be employed to mold two or multi-colored parts by zoning the mold to heat one portion of the mold first. Once the material has adhered to the mold wall the other color mold material can be added and other portion of the mold heated to produce multi colored parts. For instance, if zebra stripes on an object were desired, the white stripes can be heated first with white colored material charged in the mold. Once the white stripes have been sufficiently molded, the heat paint or electrothermic material corresponding to the white stripes is turned off and the heat paint corresponding to the black stripes is heated. The black material is then loaded into the mold via a drop box, for example, and the mold is rotated to complete the zebra striped object.

The present invention can also mold graphics into a desired portion of the object. For instance, logos and/or graphical designs can be molded into the object using a method similar to that described above. In other words, the logo and/or graphical design can have corresponding heat paint to selectively heat the logo and/or graphical design apart from the rest of the molded object.

Although an entirely new rotational molding machine has been introduced herein, it is recognized that the electrodes and electrothermic layer or coating can be applied to any of the conventional, existing molds to reduce cycle times. Because conventional molds are typically constructed from relatively heavy wall steel (nickel plated) or aluminum, the molds will not cool as quickly as the relatively thinner wall polymer, ceramic, nickel-plated steel, aluminum, or plain steel molds of the present invention. Molds of the invention can be built thinner because they are not exposed to the harsh environment of the 600-degree oven. However, despite the molds of the invention being exposed to lower peak temperatures, cycle times can still be significantly reduced. Another contribution to the cycle reduction is that each arm can work independently of the other due to the improved heating system.

A transitional period can be created for conversion of a prior art rotational molding system into an improved rotational molding system. Given a four arm rotational molding system, one arm can be removed and converted to the new system, while the remaining three arms are still producing product. For instance, the first arm that can be removed from the conventional system will be removed from one of the cooling stations. Once one arm is converted, a second arm can be removed from the conventional system and converted.

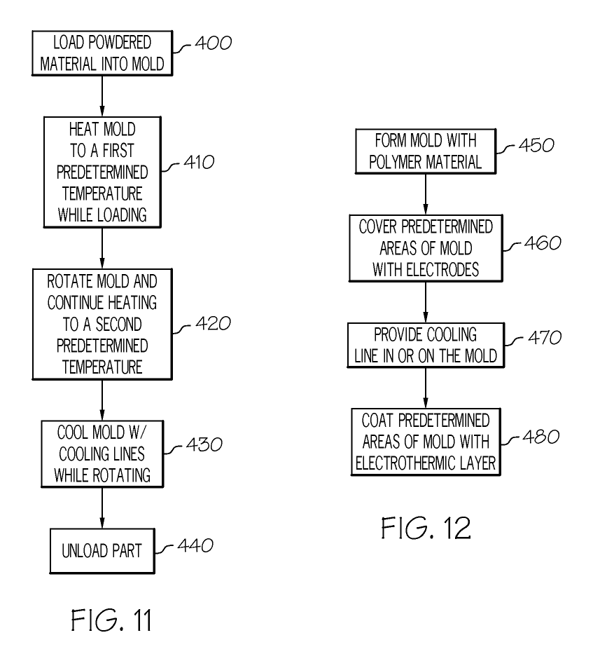

In view of the foregoing structural and functional features described above, methodologies in accordance with various aspects of the present invention will be better appreciated with reference to FIGS. 11 and 12. While, for purposes of simplicity of explanation, the methodologies of FIGS. 11 and 12 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

Turning now to FIG. 11, a rotational molding process is illustrated in accordance with an aspect of the present invention. The methodology begins at 400 when powdered material is loaded into one or more molds. The mold(s) are heated to a first predetermined temperature while being loaded at 410. Preferably, the first predetermined temperature is a temperature below the melting point of the powdered material. The mold then begins to rotate at 420 while the powdered material is heated to a second predetermined temperature. The second predetermined temperature is preferably a melting temperature of the material to give a suitable viscosity for coating the mold surface. Once the mold has been sufficiently coated, the mold continues to rotate while cooling lines integrally piped throughout the mold operate to cool the mold and the material at 430. At 440, the resultant part can be removed manually or via a robot from the mold once it has sufficiently cooled.

FIG. 12 illustrates a methodology for constructing a mold in accordance with an aspect of the present invention. The mold is formed with a polymer material or any other suitable material at 450. Preferably, the mold material is selected from a material or materials that do not conduct heat. At 460, electrodes are applied to a surface of the mold at selected areas as will later create an evenly heated surface on the mold. At 470, cooling lines are provided within the mold material or on a surface portion of the mold. Selected areas of the mold are then covered with the electrothermic layer or coating at 480. A temperature-controlling device can be coupled to the electrodes to precisely control the temperature of the mold. Or, the electrothermic layer or coating can be formulated to come up to the desired temperature.

It is to be appreciated that any of the systems described herein can be operated via a plurality of methods. For example, a laptop computer or personal digital assistant could be employed to wirelessly send instructions to the rotomolding system to begin, pause, end, or change a process.

It is to be appreciated that the heating processes described herein can be employed for preheating powdered materials, and as such, have wide applicability. For instance, preheating powdered materials can be employed, for example, in numerous types of plastic processing applications, such as rotomolding, extrusion, compounding, injection molding, blow molding, and film casting, auxiliary processing, forming operations, preform manufacturing systems, etc. The powder preheating systems and methods can be utilized in any suitable application that can benefit from preheating plastics and any other contemplated materials. Further still, it is to be appreciated that the heat paint used to preheat the mold can also be employed to dry plastic materials before molding.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A molding system comprising:
at least one molding machine having at least one mold with wall areas for defining the shape of a part to be molded, the at least one mold having a substantial part of its wall areas directly heated with electrothermic material, the electrothermic material being adapted to heat raw material present within the at least one mold;
a conveyor line associated with each machine for moving at least one completed part away from the at least one molding machine; and
at least one assembly and/or packing station for receiving the at least one completed part from the conveyor line.

2. The molding system of claim 1, comprising at least two molding machines, each molding machine having a corresponding assembly and/or packing station.

3. The molding system of claim 1, comprising at least two molding machines, each molding machine having a corresponding conveyor line, each conveyor line leading to a single assembly and/or packing station.

4. The molding system of claim 1, further comprising at least one robot associated with each molding machine, the robot being adapted to load and unload a corresponding molding machine.

5. The molding system of claim 1, wherein the at least one molding machine is adapted to selectively heat or cool the material present within the at least one mold.

6. The molding system of claim 1, wherein the at least one mold includes a plurality of electrodes coupled to the electrothermic material.

7. The molding system of claim 1, further comprising a temperature-controlling device to control the temperature of the electrothermic material.

8. The molding system of claim 1, wherein the at least one molding machine is a rotational molding machine.

9. A molding machine comprising:
at least one mold, the mold having wall areas that are arranged to shape a part to be molded and being adapted to receive material within an interior portion of the mold;
an electrothermic material arranged to directly heat substantial portions of said wall areas; and
at least two electrodes in electrical contact with said electrothermic material positioned between the mold surface at the electrothermic layer or coating,
wherein the electrothermic material is adapted to conduct heat substantially evenly over the heated wall areas of the mold.

10. The molding machine of claim 9, further comprising a temperature-controlling device to control a temperature of the electrothermic material.

11. The molding machine of claim 9, wherein electrodes are adapted to supply electricity directly to the electrothermic material.

12. The molding machine of claim 9, wherein the at least two electrodes comprise a thin foil, electroplated metal film or perforated sheet-like material.

13. The molding machine of claim 9, wherein the at least two electrodes are powered by one of a 12, 24, 110-120, 220-240, and/or 440-480 volt electrical connection.

14. The molding machine of claim 9, wherein the electrothermic material is formulated for a desired voltage and heat.

15. The molding machine of claim 9, further comprising cooling lines coupled to the at least one mold, the cooling lines being adapted to cool the mold and the material present within the mold.

16. The molding machine of claim 9, further comprising cooling lines incorporated into the mold body, the cooling lines being adapted to cool the mold and the material within the mold.

17. The molding machine of claim 9, comprising at least two axes, each of the axes having one or more posts adapted to pipe fluid into the system for cooling lines and one or more posts adapted to pipe electrical wiring to the mold.

18. The molding machine of claim 9, wherein the mold includes movable parts therein to create sophisticated part configurations.

19. The molding machine of claim 9, wherein the mold includes a logging device coupled thereto.

20. The molding machine of claim 9, wherein the molding machine is a rotational molding machine.

21. A molding method comprising:
loading a powdered material into a mold;
heating the mold via an electrothermic material applied to a surface or being part of the mold to a first predetermined temperature, the first predetermined temperature being suitable for fully melting the powdered material; and
once the material has been fully melted, cooling the mold via cooling lines coupled to the mold.

22. The molding method of claim 21, further comprising heating the mold to a second predetermined temperature via the electrothermic material prior to loading the powdered material into the mold, the second predetermined temperature being above room temperature and below a melting point of the powdered material.

23. The molding method of claim 21, further comprising selectively heating different areas of the mold via the electrothermic material.

24. The molding method of claim 23, wherein the different areas of the mold are selectively heated to different temperatures.

25. The molding method of claim 21, wherein at least one of a 12, 24, 110-120, 220-240, and/or 440-480 volt electrical connection is used to heat the mold via the electrothermic material.

26. An electrothermic material layer arranged to contact a material being processed with heat transfer from the electrothermic layer or to contact an intermediate layer or layers of which one is in direct contact with the material being heat processed with heat transfer from the electrothermic layer, the electrothermic layer or the intermediate one layer being capable of assisting to shape or maintaining the shape of the material being so processed, the electrothermic layer being arranged to substantially envelop the material being processed or at least arranged to be substantially co-extensive with a large portion of the surface of the material being processed whereby the conductive heat transfer area is at least a relatively large part of the surface being shaped or maintained of a side of the material being processed, so as to promote a high rate of heat transfer between the electrothermic layer and the material being processed.
